(19) United States
(12) Patent Application Publication
(10) Pub. No.: US 2011/0314397 A1
(43) Pub. Date: Dec. 22, 2011

(54) MODERATOR CONTROL FOR MANAGING DELEGATES OF AN ELECTRONIC COMMUNICATION SESSION

(75) Inventors: DAVID M. OGLE, CARY, NC (US); BRYAN D. OSENBACH, CARY, NC (US); JEREMY B. SUSSMAN, BEDFORD HILLS, NY (US)

(73) Assignee: INTERNATIONAL BUSINESS MACHINES CORPORATION, ARMONK, NY (US)

(21) Appl. No.: 12/818,639

(22) Filed: Jun. 18, 2010

(51) Int. Cl. G06F 15/16; G06F 3/048

(52) U.S. Cl. 715/764; 709/223

(57) ABSTRACT

Within a communication system, a real time communication session comprising a set of participants and a session moderator can be defined. At least a portion of the participants can be geographically remote from each other and can be communicatively linked via networked computing devices, each enabling participation with the real-time communication session. It can be determined that one of the participants is not able to participate in the real time communication session. At least one delegate able to substitute for the one participant subject to approval of the moderator can be ascertained. The ascertained delegate can be substituted for the one participant for the real-time communication session.

### BACKGROUND

The disclosure relates to the field of communications and, more particularly, to improved moderator control for managing delegates of an electronic communication session (e.g., collaborative meeting, conference call, Web conference, etc.).

Collaborative meetings, such as conference calls, often have assigned roles for the participants. One or more of these roles may be required to effectively conduct a meeting. Further, one role (e.g., that of a moderator) can provide advanced capabilities to control electronic tools that facilitate the collaborative meeting. These moderators possess system permissions and responsibilities that other conference participants do not.

For instance, moderators of conference calls (e.g., Web conference) are frequently tasked with managing participant attendance, moderating participant communication, presenting information to participants, and in some instances, coordinating discussions. These tasks can be demanding and many solutions have been devised to assist moderators in these arenas.

One common problem that persists today is effective managing of participant attendance. In many instances, mandatory participants can be late or absent from conference calls. In these instances, the moderator is tasked with finding a delegate (or substitute) to participate on behalf of the late/absent participant.

Currently, moderators must manually determine delegates (or substitutes having an appropriate role within scope of the collaborative meeting) for the conference call. At present, this is an ad hoc process which is not integrated into the system that performs the conferencing. Further, this can be a time consuming process which can distract the moderator from more important tasks (e.g., coordinating discussions, functioning as a meeting participant in addition to performing the moderator role, etc.). The process can involve querying one or more of the participants for a suitable substitute or delegate. The moderator then locates contact information for that delegate, and contacts the delegate to determine their willingness/ability to substitute for the missing participant. In some instances, participants may be unaware of an appropriate delegate, leaving the moderator unable to properly conduct the conference call.

Further, often times the moderator can be unfamiliar with participants making it difficult to determine an appropriate delegate for missing participants when the participants themselves are not aware of an appropriate delegate. In these instances, the moderator can utilize email information (e.g., reading the “cc” field”) to track down an appropriate delegate. Since many recipients can be listed in the “cc” field, moderators can have difficulty in rapidly determining and contacting an appropriate delegate for a missing participant. For example, a recipient in an email can be a delegate for a participant, a participant administrator, a team member, or a non-participating party, etc. That is, the moderator cannot easily determine an appropriate delegate for the absentee participant. Subsequently, current approaches are cumbersome and time consuming leaving moderators with little control over managing delegates for conference calls.

### SUMMARY

One aspect of the disclosure presents a method, system, and interface for improved moderator control of a communication session. In the aspect, within a communication system, a real time communication session comprising a set of participants and a session moderator can be defined. At least a portion of the participants can be geographically remote from each other and can be communicatively linked via networked computing devices, each enabling participation with the real-time communication session. It can be determined that one of the participants is not able to participate in the real time communication session. At least one delegate able to substitute for the one participant subject to approval of the moderator can be ascertained. The ascertained delegate can be substituted for the one participant for the real-time communication session.

Another aspect of the disclosure is a interface, system, and method for an interface for improved moderator control of delegates comprising a display hardware within with an interface window is displayed, a tangible memory storing at least one computer program product and a processor operable to execute the computer program product to cause the interface window to be displayed by the display hardware. The interface window can be used to determine after a predefined amount of time after the commencement of an electronic communication session that a first participant to the session is absent from the session. The delegate for the first participant can be programmatically identified for the session. The delegate can be notified of the session in one or more automated means. The delegate can be invited and/or joined to the session without manual user intervention.

### BRIEF DESCRIPTION OF THE SEVERAL VIEWS OF THE DRAWINGS

FIG. 1 is a schematic diagram illustrating a method for improved moderator control for managing delegates of an active electronic communication session in accordance with an embodiment of inventive arrangements disclosed herein.

FIG. 2A is a schematic diagram illustrating a system for improved moderator control for managing delegates of an electronic communication session (ECS) in accordance with an embodiment of inventive arrangements disclosed herein.

FIG. 2B is a schematic diagram illustrating a data set for improved moderator control for managing delegates of an electronic communication session (ECS) in accordance with an embodiment of arrangements disclosed herein.

FIG. 3 is a flowchart illustrating a method for improved moderator control for managing delegates of an electronic communication session in accordance with an embodiment of inventive arrangements disclosed herein.

FIG. 4 is a schematic diagram illustrating a dialog for improved moderator control for managing delegates of an electronic communication session in accordance with an embodiment of inventive arrangements disclosed herein.

### DETAILED DESCRIPTION

The disclosure presents a solution for improved moderator control for managing delegates of an electronic communication session. In the solution, a delegate for a participant of an electronic communication session (e.g., audio conference call) can be automatically identified. Identification of the delegate can be achieved through one or more user-established rules, through automatically established rules, and/or through user established alternatives (delegates) entered and stored in the system. In one instance, the identified delegate and associated contact information can be presented during an active electronic communication session to a moderator when the participant is late/absent. In the embodiment, an appropriate delegate can be automatically contacted (e.g., via user interface interaction) when the participant is absent from the session.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

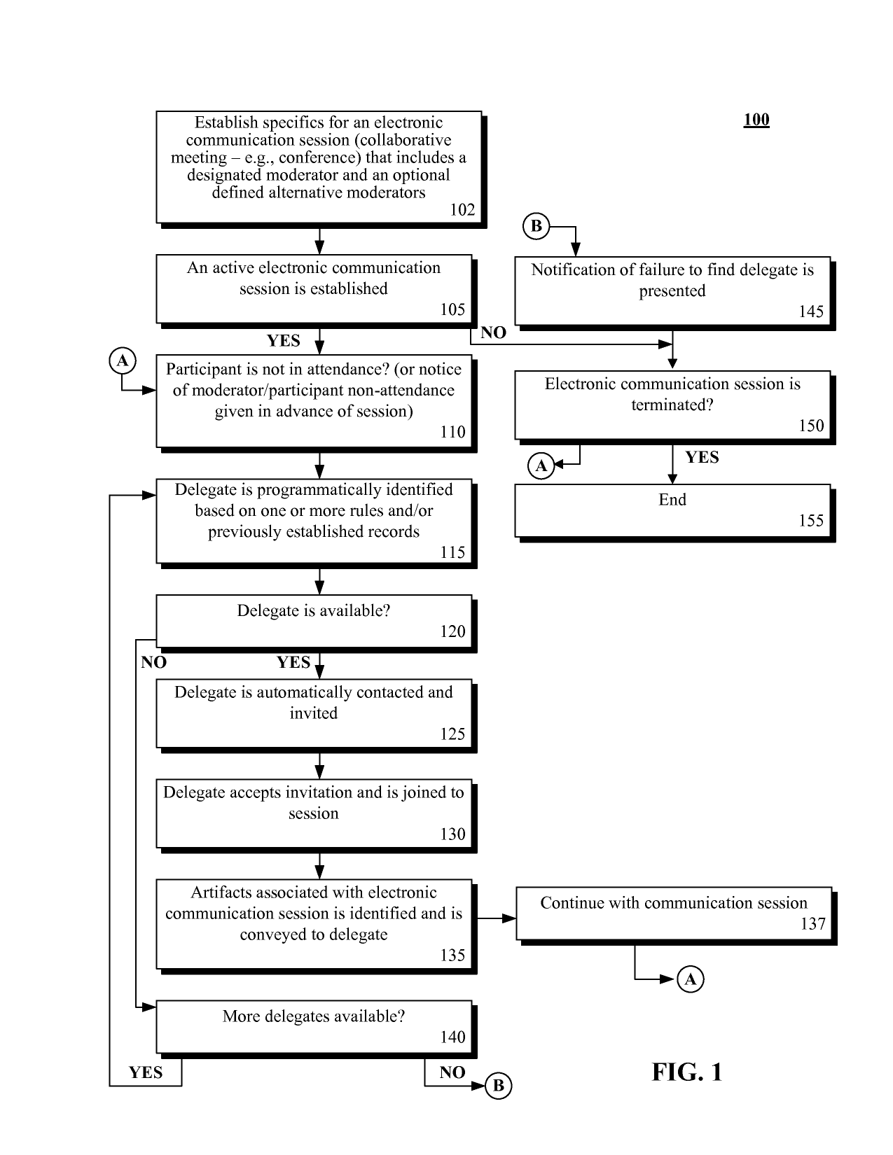

FIG. 1 is a schematic diagram illustrating a method 100 for improved moderator control for managing delegates of an electronic communication session (e.g., online meeting, conference call, Web conference, etc.) in accordance with an embodiment of inventive arrangements disclosed herein. The electronic communication session can be a real-time communication session having a set of two or more (commonly more than two) participants who are remotely located from each other. In method 100, a moderator can perform facilitation actions for a communication session. That is, the moderator can be a role established for the electronic communication session, which has special administrative privileges within system software to facilitate the session and/or which has special responsibilities relating to the conducting of the session. The moderator can be a session participant (e.g., a participant having multiple meeting roles) or can be a non-participant whose sole responsibility during the session is to facilitate of the session. In one embodiment, the moderator (having responsibility of facilitating the session, but not being an active participant) can be excluded from the content conveyed during the session (which may be confidential). In one embodiment, the role of the moderator can be performed by a software program (which may optionally be an intelligent or semi-intelligent one) performing the role of the moderator, which is a role otherwise filled by a human being that is assisted by computer implemented tools/programs.

Regardless of role specific limitations, privileges, and the like, the moderator and/or software used by the moderator can identify and contact an appropriate delegate (e.g., a substitute) for a participant of the electronic communication session (e.g., online meeting, conference call, etc.) and can take actions to permit the delegate to take the place of the corresponding person for purposes of the session. This replacement can occur in advance of the session, during the session, or even after the session is conducted (in the case of follow-on action items, break-out groups, etc. that result from the session). For instance, if a participant is a decision maker for a training session, and is absent, a delegate for the decision maker can be determined and invited to the training session.

Moderator responsibilities can include, but are not limited to, determining delegates for participants, contacting delegates of participants, starting the session, inviting participants/delegates to the session, removing participants/delegates from the session, and/or the like. These responsibilities can be fulfilled and/or facilitated by software tools that assist the moderator.

The method 100 can begin in step 102, where specifics for an electronic communication session (e.g., collaborative meeting) can be established. These specifics can define participants and their roles. A moderator can be defined for the communication session. Further, participants can optionally define delegates, who are to substitute for them in the event that the participant is unable to participate in the communication session. Delegates can be defined for a particular meeting and/or can be established as a set of ongoing substitutes able to take the participant's place for any meeting, for meetings missed on a specific project, etc. In one embodiment, participants themselves may not define the delegates, but a supervisor or other authorized individual may define the delegates.

In step 105, the electronic communication session can be established, in which case participants call, login, or otherwise joint the session. In step 110, one or more participant in the electronic communication session may be unexpectedly absent.

This absence may be noted in advance of the session, in which case equivalent steps are performed to those expressed in method 100, but may occur at a more leisurely pace. Method 100 intentionally emphases a dynamic situation where absences occur unannounced (or even during the course of a meeting, when a participant is unexpectedly pulled away from the meeting), as such as situation emphasizes the real-time capabilities and dynamic responsiveness of method 100, available in one contemplated embodiment of disclosure.

When no absences are detected in step 110, the session can proceed as normal until termination, as shown by proceeding from step 110 to step 150. It is notable that the communication session can be monitored for its duration, so if a participant leaves mid-meeting, a substitute can be situationally found, which is indicated in FIG. 1 by selectively branching from step 150 back to step 110.

If there is an unexpected absence (as determined by step 110), a substitution or delegate may or may not be needed. A need for a delegate or not can depend upon characteristics and/or the role of the absent participant. In one instance, the role of the absent participant may be immediately fulfilled by a different participant, who can thus have increased responsibilities for the communication session over those expected. Further, a cascading effect is possible, where adding a role (such as a moderator role) to the different participant can cause one of the existing roles of that person to change, which may require a delegate be found for that existing role.

All of this information can be maintained in a meeting facilitation system that the moderator has access to. The flow of the method 100 assumes that the missing participant (determined in step 110) is an essential one, for whom a delegate is needed. Thus, the method can process from step 110 to step 115, where a delegate for the participant can be identified. This identification can be based on the execution of programmatically rules, which can be responsive to variable conditions. The identification can also be based on previously designated alternatives, such as those optionally defined in step 105. The identification can be a manual one (performed by the monitor using software implemented tools), a semi-manual one (performed by selections of the moderator as assisted by software implemented tools), or an automatic one (which may or may not provide notice to a human moderator or prompt the human moderator for approval). Variable conditions triggering a need for a delegate can include participant absenteeism, tardiness, communication problems, and the like. These conditions can be automatically detected by a computing system facilitating the session.

When roles are invoked to determine a delegate, the rules can determine a set of multiple potential delegates (greater in quantity that needed) and can optionally prioritize among multiple potential delegates. When prioritized, a most preferred delegate with the most favorable score can be contacted first to determine availability (step 120), followed by the next most favorable, and so forth (the cyclic nature of delegate selection is shown by the decision loop of step 140). More specifically and as shown by step 120, if a preferred delegate is available the method can proceed to step 125, else continue to step 135. Delegate availability can be automatically identified utilizing one or more criteria including information obtained from scheduling information (e.g., calendaring data), presence information, and the like. It can also be determined by success/failure of an attempted communication for bringing the delegate into the communication session.

Various mechanisms can be used to invite a delegate into the communication session (step 125). In one instance, session information can be communicated to the delegate permitting the delegate to join the session. Session information can include, but is not limited to, phone number, Uniform Resource Locator, personal identification number (PIN), and the like. The delegate can be contacted utilizing one or more means including, but not limited to, telephony call, video conferencing call, email, Short Message Service (SMS) text, Instant Message (IM), paging, and the like. In step 130, the delegate can optionally accept the invitation, which results in the delegate being added to the communication session.

In one embodiment, the delegate can communicate with the session utilizing a communication mode identical to the session. For instance, a delegate can be joined to an audio telephone conference via a telephone call. In another instance, the delegate can communicate via a medium different than the session. For example, the delegate can communicate with participants of a Web conference via instant messaging. In one instance, assistive technologies, such as text-to-speech, speech-to-text, telepresence, and the like can be utilized to enable mixed mode communication with delegates and participants of the session.

In step 135, artifacts (e.g., documentation) associated with the electronic communication session can be identified and can be conveyed to the delegate. These are artifacts that can be useful to a delegate to participate in the communication session. Artifacts can be identified and conveyed manually and/or automatically. In one instance, artifacts can be identified from settings associated with the session, a calendar event, and the like. In another instance, artifacts can be identified manually by a moderator and/or participant. The artifacts can be conveyed via one or more electronic mechanisms including, but not limited to, email, instant messaging file transfer, File Transfer Protocol (FTP), and the like. In step 137, the session can continue, with the delegate now fulfilling the place of the corresponding participant.

In step 140, if more delegates are to be added to the communication session, assuming a pool of potential delegates has yet to be exhausted, the method can proceed from step 140 to step 115 where actions to add additional delegates can be taken. Although it is common for a one-to-one substitution between absent participants and delegates to occur (i.e., one delegate replaces one absentee), this is not necessarily the case in all instances. For example, expertise of an absent participant may require a substitution of two or more delegates. In another example, a single delegate may be able to substitute for more than one absent participant.

Additionally, substitution of a delegate for a participant need not be total. For example, a participant may not be able to be present for a video teleconference (e.g., participating in the session with bidirectional voice and video streams) as expected, but may participate within the communication session through audio only teleconferencing. A delegate may be needed to perform a set of limited roles or actions that the participant (present, but not using an anticipated set of communication modes) is unable to perform due to a more limited nature of their current communication mode(s) (e.g., may not be able to show documents to other participants easily, as they are participating within the meeting via a non-visual communication mode, such as a telephone).

When insufficient delegates are able to be found, the method can proceed to step 145. In step 145, a notification of failure to find a delegate can be presented. In one instance, the notification can be presented to a moderator of the session. In another instance, the notification can be presented to all participants of the session. In yet another instance, a notification can be conveyed to the participant for whom the delegate is associated with.

Drawings presented herein are for illustrative purposes only and should not be construed to limit the invention in any regard.

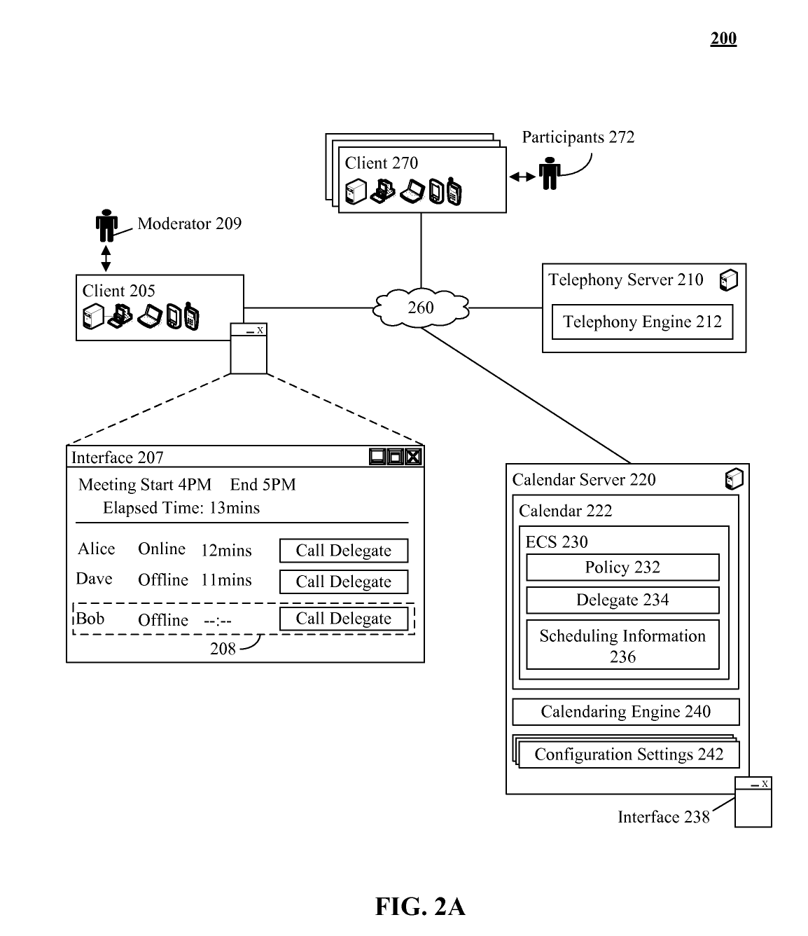

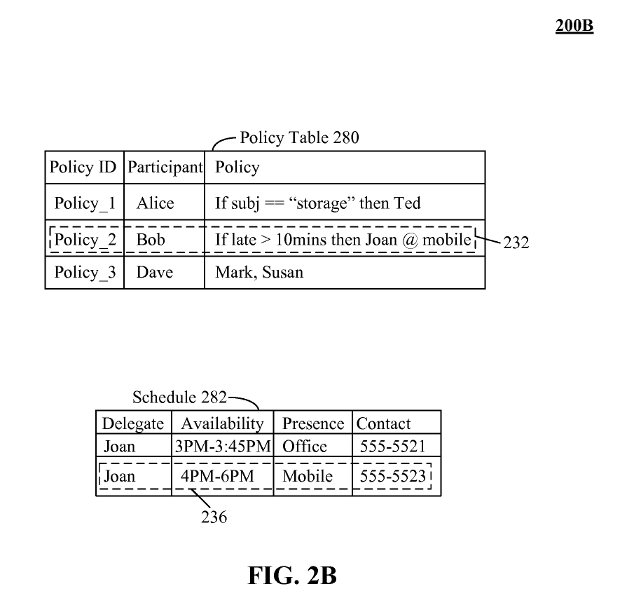

FIG. 2A is a schematic diagram illustrating a system 200 for improved moderator control for managing delegates of an electronic communication session (ECS) in accordance with an embodiment of inventive arrangements disclosed herein. In system 200, client 205 can be communicatively linked to a telephony server 210, a calendar server 220, and client 270 via network 260. Although specific examples of system 200 are tailored for telephony communications (e.g., telephony server 210), the moderator 209 is not so limited, and can apply to any type of real-time communication technology. Since telephony is a common type of collaborative technology, it is used for non-limiting illustrative purposes herein for simplicity of expression of the concept expressed.

Similarly, the ECS 230 is shown as being integrated/interactive with a calendaring server 220, which is one of many possible implementations. In another contemplated embodiment, the ECS 230 can be a stand-alone component able to perform the functions described herein. For example, the ECS 230 can provide the moderation services and delegate substitution services as a Web service to any of a variety of conferencing, online meeting, or collaboration systems.

Turning back to system 200, moderator 209 can utilize interface 207 to identify one or more delegates 234 associated with a participant prior to or during an electronic communication session (e.g., conference call, Web meeting, video teleconference, co-browsing session, text exchange session, etc.). Telephony server 210 (or other communication server, depending on the type of session and implementation choices) can allow an identified delegate 234 to be contacted during an ECS 212 via traditional telephony operations (or other real-time communication means). Employing policy table 280 (FIG. 2B) and schedule 282 (FIG. 2B), a delegate 234 can be automatically identified and contacted by system 200.

Interface 207 can be a user interface able to present controls for managing delegates within an electronic communication session (e.g., Voice over Internet Protocol three-way call, video teleconferencing). Interface 207 can comprise of element 208 which can present information about participants 272 and/or client 270. For instance, element 208 can present presence information of participants 272, delegate 234 associated with ECS 230. In one embodiment, element 208 can present a user interface entity (e.g., interactive button) permitting automated identification and contacting of a delegate 234. In the embodiment, user interaction with the entity can trigger delegate 234 to be identified and contacted utilizing policy 232 and schedule 282. In one instance, interface 207 can be a softphone application able to dynamically determine and contact delegates based on an electronic communication session associated with the softphone.

Telephony server 210 can be a hardware/software component for hosting an ECS 212 (e.g., Web conference). Server 210 can include, but is not limited to, telephony engine 216. Server 210 can be associated with one or more analog and/or digital networks including, but not limited to, a packet switched network, circuit switched network, and the like. In one instance, server 210 can be a telephony application server (e.g., IBM TELEPHONY APPLICATION SERVER).

Telephony engine 216 can be a hardware/software component for permitting telephony actions associated with contacting a delegate and managing delegate communications. Telephony actions can include, but is not limited to, identifying contact information for a delegate associated with a participant 212, contacting the delegate 234 utilizing identified contact information, performing communication actions for permitting the delegate to communicate with participants 272 of an ECS 212, and the like. Actions can be triggered from calendar engine 240 conveyance of contact information of a delegate 234. That is, when calendar engine 240 identifies a delegate to be contacted, the contact information (e.g., phone number) can be communicated to telephony engine 216, which can initiate contact (e.g., phone call) with the delegate. Interface 207 can be updated during telephony actions to indicate the current status of telephony operations (e.g., dialing) and delegate presence.

In one embodiment, engine 212 can support auto-redialing of a delegate based on one or more settings which can be automatically and/or manually established. For instance, a delegate can be called three times before another delegate is selected for contact. Further, engine 212 can identify prioritization parameters associated with a delegate enabling preferential treatment of delegates.

In one embodiment, engine 212 can be a plug-in component of a traditional telephony (e.g., Private Branch Exchange) system. In one instance, engine 212 can include, but is not limited to, IBM LOTUS SAMETIME UNIFIED TELEPHONY, ASTERISK, and the like. In another instance, engine 212 can be a component of a paid electronic communication service.

Calendar server 220 can be a hardware/software component for storing calendar 222 information associated with a participant. Calendar server 220 can comprise of, but is not limited to, user calendar 222, calendar engine 240, and the like. Calendar server 220 can include, but is not limited to, IBM LOTUS DOMINO SERVER, SUN JAVA SYSTEM CALENDAR SERVER, and the like.

Calendar 222 can be an electronic calendar able to store information associated with an electronic communication session 230. Calendar 222 can be associated with a moderator 209 and/or participants 272 scheduled to interact within an electronic communication session. That is, calendar 222 can be a user calendar owned/modifiable by moderator 209, participants 272 comprising of events associated with an electronic communication session. In one instance, calendar 222 can be a user calendar, group calendar, and the like. Calendar 222 can include, but is not limited to, ECS 230 information, appointment information, contact information, and the like.

ECS 230 can be a calendar event linked to an electronic communication session associated with a moderator 209 and/or participants 272. ECS 230 can comprise scheduling information 236, delegate 234, policy 232, and the like. ECS 230 can include, but is not limited to, information associated with an audio conference, a video conference, an audio/video conference, a mixed-mode conference, a text exchange session, and the like. Information can include, but is not limited to, date, time, subject, venue, moderator information, participant information (e.g., participation name, participation status, etc), and the like. In one instance, ECS 230 can be a multi-point videoconference comprising of multiple sets of participants 272 and moderators 209. In one embodiment, ECS 230 can be one of a series of electronic communication sessions. In the embodiment, one or more delegates can be established for each occurrence of the ECS 230, for all occurrences of an electronic communication session, and the like.

Policy 232 can be a rule for identifying and/or contacting a delegate 234 associated with an ECS 230. Policy 232 can be user defined and/or automatically determined based on server 220 settings, calendar 222 settings, ECS 230 parameters, configuration settings 242, and the like. Policy 232 can define which delegate 234 to contact and/or the methods of contacting the delegate 234. For instance, policy 232 can specify to contact Joan on her mobile phone when Bob is ten minutes late for a conference call. In one instance, policy 232 can comprise of natural language constructs. In another instance, policy 232 can conform to formal language structure. For instance, policy 232 can include syntax comparable to computer programming languages (e.g., if, then, else). In one instance, policy 232 can be weighted to permit multiple rules to be utilized to determine an appropriate delegate.

Scheduling information 236 can be information associated with a delegate 234 schedule. That is, scheduling information 236 can be used to indicate delegate 234 availability, presence, contact information, and the like. Information 236 can be associated with one or more delegates 234 permitting multiple delegates to be determined for an ECS 230 associated with a participant.

Interface 238 can be a user interface for permitting configuration of policy 232, modifying delegate 234 settings, modification of scheduling information 236, and the like. In one instance, interface 238 can be a screen from a client-side calendaring software. In the instance, interface 238 can be a screen of an IBM LOTUS NOTES software. In one embodiment, interface 238 can be utilized to specify global rules for identifying and contacting delegates. Global rules (e.g., policy 232) can be established permitting standardized delegate substitution procedures to be supported. For instance, corporate policies for participation within electronic communication sessions can be accommodated easily utilizing a global rule configuration.

In one embodiment, interface 238 can permit identification and contacting of an appropriate delegate from within the interface 238. For example, interface 238 can present a hyperlink associated with an appropriate delegate which when interacted with, automatically calls the delegate.

Calendar engine 240 can be a hardware/software component for automatically identifying and/or contacting an appropriate delegate 234 for an ECS 230. Engine 240 can be used to automatically construct policy table 280, validate policies, and the like. In one instance, engine 240 can heuristically determine an appropriate delegate 234 based on historic information. Historic information can include, historic delegates, historic policies, and the like. In one embodiment, engine 240 can be used to automatically generate schedule 282. Engine 240 can utilize one or more automatically and/or manually established settings (e.g., configuration settings 242) for delegate identification and contact resolution. For instance, when a delegate is unavailable, engine 240 an utilize a user defined priority setting to determine the next delegate to contact.

Policy table 280 can be one or more rulesets for identifying and/or contacting a delegate 234 associated with an ECS 230. Table 280 can be associated with a calendar server 220, distributed data store, network attached storage, and the like. In one instance, table 280 can be a portion of a database including, but not limited to, a relational database management system (RDBMS), object-relational database management system (ORDMBS), federated database, and the like.

Schedule 282 can be one or more portions of scheduling information associated with a delegate 234. Schedule 282 can include, but is not limited to, delegate identification information, delegate scheduling information, presence information, contact information, and the like. For instance, schedule 282 can be used to indicate the best contact location for a delegate during specific hours of the day. In one instance, schedule 282 can be used to automatically forward an invitation to the ECS 230 based on presence information.

Client 205, 270 can be one or more computing devices communicatively linked to facilitate a electronic communication session. In one instance, client 205, 270 be a dedicated electronic communication session. For example, client 205, 270 can be a telepresence room configured for videotelephony. In one embodiment, client 205, 270 can be an IBM LOTUS SAMETIME CONNECT client, IBM SAMETIME UNIFIED TELEPHONY client, and the like.

Network 260 can be one or more networks communicatively linking system 200 elements. Network 260 can include, public networks, private networks, virtual private networks, and the like. Network 260 can be a Transmission Control Protocol/Internet Protocol (TCP/IP) network, IPsec network, and the like. In one embodiment, network 260 can be the Internet.

In one instance, configuration settings 242 can be utilized to control security procedures associated with system 200. In the instance, settings 242 can specify authentication mechanisms to use for contacting delegates, security restrictions on which delegates can be selected, and the like. Further, settings 242 can be used to resolve access control conflicts. For instance, settings 242 can enable private calendars to be accessible to engine 240 for purposes of delegate identification.

Drawings presented herein are for illustrative purposes only and should not be construed to limit the invention in any regard. In one instance, engine 240 can be a network element communicatively linked to system 200. It should be appreciated support systems can be integrated into system 200 to create additional flexibility and robustness. For instance, a file repository can be utilized to convey artifacts (e.g., task lists, action items, minutes, etc) to delegates. In one embodiment, system 200 functionality can be encapsulated within a Web-enabled service. In the embodiment, system 200 can be a Service Oriented Architecture (SOA), enabling real-time participant substitution within electronic communication sessions.

Further, calendaring services (e.g., task tracking, scheduling activities) associated with the participant can be exposed to the delegate to enable the delegate to completely substitute for a participant. In one instance, the exposed services can be available for the duration of the ECS 230 for which the delegate is participating. Additionally, collaborative resources (e.g., shared files, calendars) can be exposed temporarily to a delegate. It should be appreciated, exposed services can be securely accessed utilizing one or more traditional and/or proprietary mechanisms (e.g., encryption).

In one embodiment, delegate 234 can be identified and/or contacted utilizing directory service (not shown). A directory service can be used to provide information about participants and/or delegates including, but not limited to, technical expertise, project information, presence information, and the like.

In instances where a delegate cannot fulfill the responsibilities, another delegate can be programmatically determined utilizing interface 207. For instance, a delegate can notify moderator 209 of request to leave a session, which can present moderator with a notification and options for replacing the delegate.

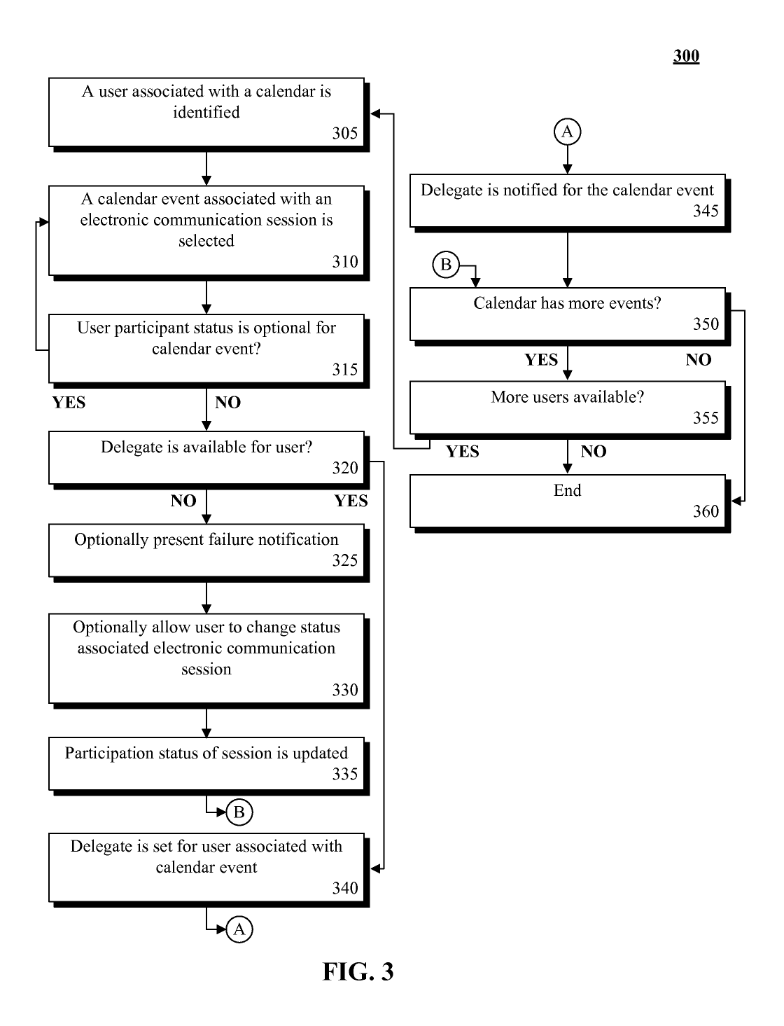

FIG. 3 is a flowchart illustrating a method 300 for improved moderator control for managing delegates of an electronic communication session in accordance with an embodiment of inventive arrangements disclosed herein. Method 300 can be performed in the context of system 200. In method 300, a calendaring engine can automatically determine appropriate delegates for an event associated with a electronic communication session within a calendar. Method 300 presents a specific case of the disclosure, where communication session information is integrated to a calendaring application.

In step 305, a user associated with a calendar can be identified. The user can be manually or automatically identified. For example, the user can be selected by a moderator during (or before) a conference call (i.e., one type of electronic communication session). In step 310, a calendar event associated with an electronic communication session can be selected. The event can be selected utilizing a variety of mechanisms including, but not limited to, keyword analysis, event type detection, and the like. In step 315, if the user participation status is configured as optional for the event, the method can return to step 310, else continue to step 320. In step 320, if a delegate is available for the user, then the method can proceed to step 340, else continue to step 325. Delegate availability can be determined utilizing scheduling information, expertise criteria, relationship parameters, and the like. For instance, a delegate can be randomly chosen from a team when a team member is unable to attend a Web conference.

In step 325, a failure notification can be optionally presented. The failure notification can be presented within a telephony interface, calendar interface, email interface, and the like. In step 330, a user can be optionally allowed to change the participation status associated with the electronic communication session. In one instance, the user can be presented with an interface for modifying participation status. In another instance, the user can receive an email permitting modification of participation status. In step 335, participation status of the session can be updated. In one instance, step 335 can trigger a programmatic action to be performed including, but not limited to, notification messages to be conveyed to participants, invoking a scheduling change request, and the like.

In step 340, a delegate can be set for the user associated with the calendar event. In step 345, the delegate can be notified of invitation to the calendar event. In step 350, if the user calendar has more events, the method can continue to step 355, else proceed to step 360. In step 355, the method can continue to step 360, else return to step 305. In step 360, the method can end.

Drawings presented herein are for illustrative purposes only and should not be construed to limit the invention in any regard. Method 300 can be performed automatically via an operating system service, Web service, and the like. In one instance, method 300 can be functionality of a calendar plug-in. In another instance, method 300 can be a functionality of a middleware software.

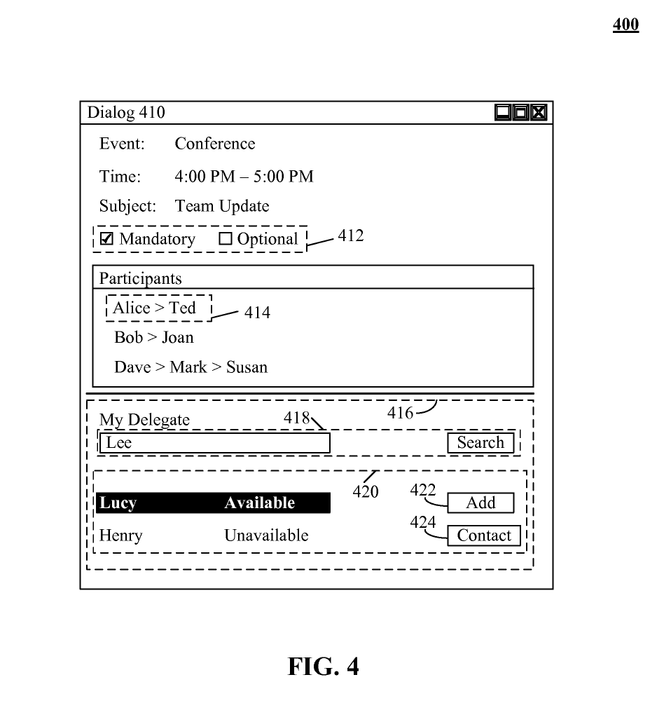

FIG. 4 is a schematic diagram illustrating a dialog 410 for improved moderator control for managing delegates of an electronic communication session in accordance with an embodiment of inventive arrangements disclosed herein. Dialog 410 can be presented within the context of method 100, 300, and system 200. Dialog 410 can be associated with a calendaring system (e.g., calendar server 220). Dialog 410 can be a screen within a calendar interface (e.g., interface 238). Dialog 410 can permit management of delegates for an event within a calendar. In one embodiment, dialog 410 can allow a participant to modify participation status, view delegates of other participants, and manage delegates.

Section 412 can permit participants to modify participation status of an event associated with an electronic communication sessions. In section 412, a set of participation status indicators can be presented to a participant. The indicators can determine when a delegate can be specified for an event. Participation status indicators can include, but are not limited to mandatory, optional, and the like. For instance, when the indicator is set to mandatory, a delegate can be specified. Section 412 can present one or more selection mechanisms (e.g., checkboxes) for adjusting the status of a participant associated with the event. Upon modification, changes can be propagated to appropriate calendar events which are shared. For example, when a participant changes their status to optional, the change can be updated within each calendar associated with participants of the event.

In section 414, participants and the associated delegates can be presented. For example, section 414 can present in order the participant (e.g., Alice) and delegates (e.g., Ted) for the event. In one embodiment, section 414 can be modified by a user having sufficient privileges (e.g., administrator). In one instance, a moderator for the event presented in dialog 410 can specify delegates for each participants utilizing section 416.

In section 416, delegates for an event can be manually configured by a participant associated with the event. Section 416 can include, but is not limited to, a searching component 418, a search result 420, and interface artifacts 422, 424. In one instance, section 416 can be optionally hidden when an “optional” participation status is selected.

Searching component 418 can be a search functionality (e.g., directory search) enabling searching of potential delegates for an event. In one instance, component 418 can permit keyword, name, date/time searching capabilities, and the like. In one instance, search parameters can be automatically identified utilizing event information presented within dialog 410.

Search result 420 can present one or more potential delegates resulting from a search invocation by component 418. Result 420 can present information regarding potential delegates including, but not limited to, name, availability, contact information, and the like. In one instance, results 420 can present interface artifact 422 permitting addition of an available delegate to the event associated with a participant of the event. In another instance, result 420 can present interface artifact 424 allowing automated contacting of unavailable delegates for manual scheduling options. For instance, when a delegate is unavailable, artifact 424 can permit a participant to call the unavailable delegate to arrange delegate availability.

Drawings presented herein are for illustrative purposes only and should not be construed to limit the invention in any regard. Dialog 410 can include, but is not limited to, a graphical user interface (GUI), voice user interface (VUI), multi-modal interface, and the like. Interface elements presented within dialog 410 can include, but is not limited to, checkboxes, radio buttons, combo boxes, and the like. Functionality presented within dialog 410 can be present within drop-down menus, context menus, and the like.

The flowchart and block diagrams in the FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for improved moderator control of a real time communication session comprising:
within a communication system, defining a real time communication session comprising a plurality of participants and a session moderator, wherein at least a portion of the participants are geographically remote from each other and are communicatively linked via networked computing devices enabling participation with the real-time communication session;
determining that one of the participants is not able to participate in the real time communication session;
ascertaining at least one delegate able to substitute for the one participant subject to approval of the moderator; and
substituting the ascertained delegate for the one participant for the real-time communication session.

2. The method of claim 1, further comprising:
indicating to the moderator via a user interface the one participate and the ascertained delegate; and
receiving input from the moderate via the user interface that indicates that the ascertained delegate is approved to substitute for the one participant, wherein the substituting occurs responsive to receiving the input.

3. The method of claim 1, wherein the at least one delegate able to substitute for the one participant comprises a plurality of delegates, said method further comprising:
for each of the plurality of delegates, generating a suitability score indicating a level of suitability of the corresponding delegate to substitute for the one participant; and
prioritizing the plurality of delegates by suitability score.

4. The method of claim 3, further comprising:
attempting to get each of the plurality of delegates to agree to substitute for the one participant by starting with the delegate having the highest suitability score and proceeding downward in set of delegates based on decreasing suitability score until a delegate agrees to substitute for the participant.

5. The method of claim 1, further comprising:
presenting the moderator with contact information for the delegate, which the moderator is able to utilize to communicate with the delegate to get the delegate to substitute for the one participant.

6. The method of claim 1, further comprising:
presenting the one participant with a user interface for designating at least one delegate for the real time communication session;
receiving from the one participant information entered via the user interface that designates the at least one delegate;
storing the received information; and
presenting the stored information to the moderator responsive to determining that the one participant is not able to participate in the real time communication session.

7. The method of claim 1, further comprising:
executing a set of rules to determine a suitable person to function as the one participate, wherein suitability is based on factors specific to the real time communication session;
determining contact information for the suitable person;
receiving confirmation from the suitable person that the person will substitute for the one participant; and
responsive to receiving the confirmation, confirming the suitable person as the ascertained delegate and substituting the suitable person for the one participant for the real time communication session.

8. The method of claim 1, wherein the real time communication session is a conference call, wherein the substituting occurs within records of the communication system.

9. The method of claim 1, wherein the defining of the real-time communication session occurs within a calendaring system that maintains calendar entries for each of the participants and the session moderator.

10. The method of claim 1, further comprising:
automatically sending an invitation request via the communication system to the ascertained delegate, said invitation indicating that the delegate is requested to replace the one participant during the real time communication session;
receiving a response to the invitation request, said response indicating an agreement to replace the one participant; and
responsive to and contingent upon receiving the response, substituting the ascertained delegate for the one participant.

11. The method of claim 1, wherein the determining that the one participant is not to participate in the real time communication session occurs when the one participant fails to join the real time communication session within a defined time boundary of the start of the real time communication session;
automatically notifying the moderator that the one participant has failed to join the real time communication session within the defined time boundary;
receiving a substitution approval or request from the moderator; and
responsive to receiving the substitution approval or request, substituting the ascertained delegate for the one participant.

12. The method of claim 1, wherein the one participant is part of the real time communication session when the real time communication session is initiated;
detecting that the one participant disconnects from the real time communication session during the real time communication session; and
responsive to detecting that the one participant disconnects, ascertaining the at least one delegate and substituting the delegate, wherein the substituting of the delegate occurs during the real time communication session and before the real time communication session ends.

13. The method of claim 1, wherein the real time communication session is a conference call, wherein the determining that the one participant is not able to participate occurs during the conference call, said method further comprising:
calling a phone number associated with the delegate to establish a telephony connection with the delegate;
the moderator requesting within the telephony connection that the delegate join the conference call; and
when the delegate indicates an agreement to join the conference call, connecting the delegate to the conference call that is already in session.

14. A computer program product comprising a computer readable storage medium having computer usable program code embodied therewith, the computer usable program code comprising:
computer usable program code stored in a tangible storage medium operable to, within a communication system, defining a real time communication session comprising a plurality of participants and a session moderator, wherein at least a portion of the participants are geographically remote from each other and are communicatively linked via networked computing devices enabling participation with the real-time communication session;
computer usable program code stored in a tangible storage medium operable to determine that one of the participants is not able to participate in the real time communication session;
computer usable program code stored in a tangible storage medium operable to ascertain at least one delegate able to substitute for the one participant subject to approval of the moderator; and
computer usable program code stored in a tangible storage medium operable to substitute the ascertained delegate for the one participant for the real-time communication session.

15. The computer program product of claim 14, further comprising:
computer usable program code stored in a tangible storage medium operable to indicate to the moderator via a user interface the one participate and the ascertained delegate; and
computer usable program code stored in a tangible storage medium operable to receive input from the moderate via the user interface that indicates that the ascertained delegate is approved to substitute for the one participant, wherein the substituting occurs responsive to receiving the input.

16. An apparatus including an interface for improved moderator control of delegates comprising:
a tangible memory storing at least one computer program product;
a processor operable to execute the computer program product to cause the interface window to be displayed by the display hardware; and
the computer program product when executed by the processor being operable to determine a predefined amount of time after commencement of an electronic communication session that a first participant to the session is absent from the session;
the computer program product when executed by the processor being operable to programmatically identify a delegate for the first participant for the session; and
the computer program product when executed by the processor being operable to contact a moderator of the electronic communication session and to receive confirmation from the moderator that the delegate to be contacted;
the computer program product when executed by the processor being operable to automatically contact the delegate to notify the delegate of the session; and
the computer program product when executed by the processor being operable to substitute the delegate for the first participant during the electronic communication session.

17. The apparatus of claim 16, wherein the electronic communication session is a real time communication session, said apparatus further comprising:
display hardware within with an interface window of a graphical user interface is displayed to the moderator;
wherein the computer program product presents a notification within the graphical user interface, said notification showing the first person is not attending the electronic communication session, wherein the confirmation from the moderator is received via the graphical user interface; and
wherein the substitution of the delegate for the first participant occurs responsive to a user command issued from the graphical user interface by the moderator.

18. The apparatus of claim 16, wherein the interface is associated with a telephony application, wherein the telephony application is a Voice over Internet Protocol (VoIP) software application.

19. The apparatus of claim 17, wherein the graphical user interface is an interface of an IBM LOTUS SAMETIME client application.

20. The apparatus of claim 17, wherein the graphical user interface is configured for displaying to a second participant in the session other than the first participant, a notification indicating the first participant is absent from the session; and
wherein the graphical user interface is configured for enabling the participant to initiate the performance of the identifying and contacting of the delegate.
